(19) United States
(12) Patent Application Publication
(10) Pub. No.: US 2026/0149731 A1
(43) Pub. Date: May 28, 2026

(54) SYSTEM AND METHOD FOR PREDICTIVE DETERMINATION OF A RESOLUTION PLAYBOOK

(71) Applicant: Radware Ltd., Tel Aviv (IL)

(72) Inventors: Avi CHESLA, Tel Aviv (IL); Sergei EDELSTEIN, Arad (IL); Idan EDRY, Ganey Tikwa (IL)

(73) Assignee: Radware Ltd., Tel Aviv (IL)

(21) Appl. No.: 18/956,707

(22) Filed: Nov. 22, 2024

(51) Int. Cl. H04L 9/40

(52) U.S. Cl. CPC H04L 63/1441

(57) ABSTRACT

A system and method for determining a resolution playbook for a cybersecurity incident is provided. The method includes applying a reasoning model to determine scores for a plurality of playbooks based on input data related to a root-cause of a cybersecurity incident, wherein the reasoning model includes a plurality of nodes of features and the plurality of playbooks arranged in a causal relationship; identifying a matching playbook based on the determined scores for the plurality of playbooks; and triggering execution of the matching playbook to resolve the cybersecurity incident.

### TECHNICAL FIELD

The present disclosure relates generally to detecting malicious cyberattacks and more specifically, to determining resolution protocols with reduced resolution time.

### BACKGROUND

A Security Operations Team (SOC) is a group of experts in an organization that is responsible for monitoring, detecting, responding to, and mitigating cybersecurity threats across the organization's infrastructure. They work to ensure the confidentiality, integrity, and availability of data and systems by continuously monitoring networks, servers, endpoints, and other critical assets. Some example roles of the SOC include, without limitation, incident detection and response, vulnerability management, security tool management, and maintaining an organization's overall security posture.

Current techniques employed by the SOC team include automated threat detection, behavioral analytics, and threat hunting, where experts proactively search for indicators of compromise (IOCs) or tactics, techniques, and procedures (TTPs) used by attackers and utilize incident response playbooks for resolutions. However, it has been identified that SOC still face challenges arising from increasing volume of alerts and false positives, false negatives, the evolving sophistication of cyberattacks, especially with the rise of ransomware and APTs (Advanced Persistent Threats), and a shortage of skilled security professionals.

To this end, the growing complexity and scale of threats are not effectively monitored and implemented in determining resolution procedure for cybersecurity incidents. Moreover, the determination of resolution procedures by the SOC often involves manual analysis and decision-making to increase a time to recovery (MTTR) from a security incident, which can result in undesired breaching of the organization's infrastructure.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining a resolution playbook for a cybersecurity incident. The method comprises: applying a reasoning model to determine scores for a plurality of playbooks based on input data related to a root-cause of a cybersecurity incident, wherein the reasoning model includes a plurality of nodes of features and the plurality of playbooks arranged in a causal relationship; identifying a matching playbook based on the determined scores for the plurality of playbooks; and triggering execution of the matching playbook to resolve the cybersecurity incident.

Certain embodiments disclosed herein also include a non-transitory computer readable medium having stored thereon causing a processing circuitry to execute a process, the process comprising: applying a reasoning model to determine scores for a plurality of playbooks based on input data related to a root-cause of a cybersecurity incident, wherein the reasoning model includes a plurality of nodes of features and the plurality of playbooks arranged in a causal relationship; identifying a matching playbook based on the determined scores for the plurality of playbooks; and triggering execution of the matching playbook to resolve the cybersecurity incident.

Certain embodiments disclosed herein also include a system for [to be completed based on final claims]. The system comprises: a processing circuitry; and a memory, the memory containing instructions that, when executed by the processing circuitry, configure the system to: apply a reasoning model to determine scores for a plurality of playbooks based on input data related to a root-cause of a cybersecurity incident, wherein the reasoning model includes a plurality of nodes of features and the plurality of playbooks arranged in a causal relationship; identify a matching playbook based on the determined scores for the plurality of playbooks; and trigger execution of the matching playbook to resolve the cybersecurity incident.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram of a determination and training process according to an embodiment.

FIG. 3 is a flowchart illustrating a method for predictive determination of a resolution playbook according to an embodiment.

FIG. 4 is a flowchart illustrating a method for monitoring a resolution playbook according to an embodiment.

FIG. 5 is a schematic diagram of a prediction system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for rapid determination of a resolution playbook based on predictions. A reasoning engine that describes relationships between cybersecurity incidents, behaviors, observations, and the like and any combination thereof is applied to generate insights and to identify an optimized resolution playbook in response to the cybersecurity incident. The disclosed embodiments identify relevant insights and playbooks concurrently during inference of the reasoning model. It should be noted that such process provides predictive determination of the playbooks which improves the accuracy and efficiency significantly.

It has been identified that rapid and accurate determination of a resolution playbook (or protocol) is critical for tackling and managing cybersecurity incidents. The embodiments disclosed herein provide a predictive determination of the resolution playbook from a plurality of playbooks. A playbook is a comprehensive guideline including one or more steps in order to effectively respond to a cybersecurity incident at a protected organization or entity. A cybersecurity incident is an event or occurrence of compromise or impact on a service and may be related to any cyber-attack that has not been detected or mitigated effectively. Depending on the incident, and the existing cyber security systems, the suitable and effective response may vary and thus, accurate identification of the incident type, root cause, and the like is desired. An incident type may include any false positive (e.g., mistakenly detected and blocked legitimate transactions), false negatives, partial mitigation, over-blocking, and similar.

The embodiments described herein employ a reasoning model to determine the best-fitting resolution playbook according to the causal relationships between various behavioral features and the detected incident. In an embodiment, security insights of the incident including, but not limited to, a type of incident, a root-cause of the incident (e.g., a service impact event), key influencers, missing features, and the like, and any combination thereof are generated. The disclosed embodiments provide such insights as output of the reasoning model which may be used as feedback to further train and improve the accuracy. Moreover, the insights enable explainable and trackable decision making in determining the best-fitting resolution playbook for the given event and observations (e.g., traffic, anomaly, etc.). It should be further noted that the insights are generated concurrent to the inference and identification of the playbook, thereby avoiding additional load at the computing resources.

Currently employed security operation center (SoC) is often dependent on a group of personnel with expert knowledge on the cybersecurity behaviors. To this end, the analysis, response, and selection of the playbook are largely subjective and would vary depending on the personnel making such decision. Moreover, any process from the incident detection to mitigation steps is limited to the knowledge and portions of the cybersecurity-relevant data available to the personnel or members of the SoC, thereby resulting a long resolution time. The embodiments disclosed herein enable objective decision, based on scores, to determine the best-fitting playbook for efficient resolution against the incident and detected behaviors. It should be noted that such objective decision based on an AI-based reasoning engine improves resolution time, for example, from days and hours to minutes or zero, to conserve computing resources. Moreover, the disclosed embodiments enable predictive determination of cause and key features (e.g., generated insights) that may be utilized to construct a more robust security system and improved security operation processes.

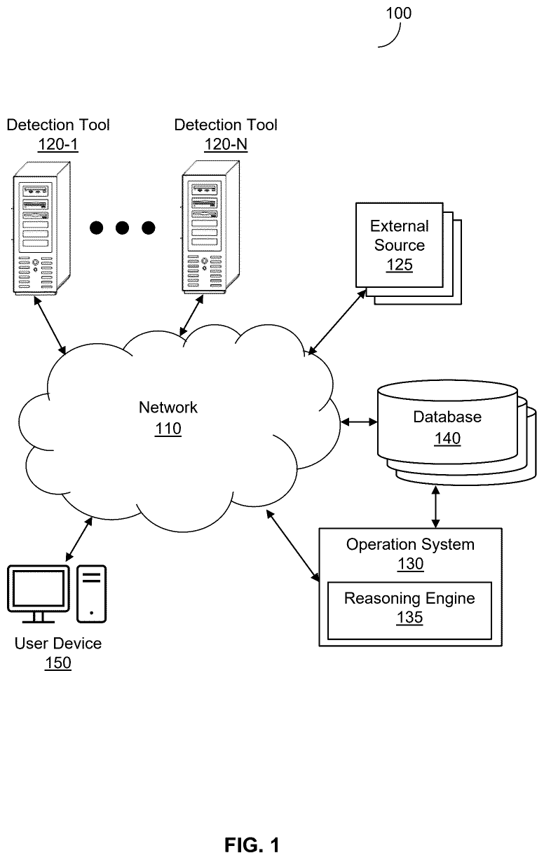

FIG. 1 is a schematic diagram 100 utilized to describe the various disclosed embodiments. In the example schematic diagram 100, a plurality of detection tools 120-1 through 120-N (hereinafter referred to individually as detection tool 120 and collectively as detection tools 120, merely for simplicity purposes), an external source 125, an operation system 130, a database 140, and a user device 150 communicate via a network 110. The network may be, but is not limited to, a wireless, cellular or wired network, a local area network (LAN), a wide area network (WAN), a metro area network (MAN), the Internet, the worldwide web (WWW), similar networks, and any combination thereof.

The detection tools 120 may be, but not limited to, a component, a server, a system, a plugin, a software, or the like configured to detect an incident, to analyze network traffic, to check application health, and the like, and any combination thereof. The detection of the incident indicates potential security threats, vulnerabilities, misconfigurations, and/or malicious activities in the organization. The detection tools 120 are implemented to monitor and analyze network behaviors including, for example, but not limited to, traffic, logs, configurations, activities, endpoint data, vulnerability scans, and the like in order to identify suspicious activities. In an embodiment, the detection tools 120 may be employed to collect and/or generated security data such as, not limited to, network protection data, application-level protection data, network analytics data, health check status, health check alerts, security configurations, and the like, and any changes and combination thereof, based on monitored behaviors associated with the organization's security, network, application status and performance, and the like. In a further embodiment, the detection tools 120 are further configured to identify potential security incidents and notify the operation system 130. A potential security incident (hereinafter simply referred to as an incident) is a potential security impact on the service, application, or the like, caused by unaddressed threat, vulnerability, malicious activity, or the like, to be investigated and handled. Some example attacks may include, but is not limited to, Denial of Service (DoS) attack techniques, Distributed Denial of Service (DDoS) attack techniques, and the like, and more.

Some examples of detection, network analytics, and health check tools, collectively shown as detection tools 120, include, for example and without limitation, security management and orchestration systems, Network analytics tools such as Kentic, health check tools, such as Zabbix, and more. The network behaviors, analysis, security data, and the like, and any combination thereof may be associated with metadata such as, but not limited to, a time stamp, an incident identifier (ID), a source identifier (ID), and the like, and more, and stored in the database 140. In some configurations, the detection tools 120 may communicate over the network 110. In some other configurations, the detection tools 120 are integrated plugins of the operation system 130.

The external source 125 may be, but not limited to, a service, a platform, a database, or the like, that stores up-to-date threat enrichment data. The external source 125 is managed by an external provider or community to provide information about, without limitation, known threats, malicious sources, vulnerabilities, attack vectors, and the like. As an example, the external source 125 may be a common vulnerabilities and exposure (CVE) database that is publicly accessible. Other examples of external sources 125 include, without limitation, regulatory agencies, community platforms, information-sharing and analysis centers (ISACs), malware analysis services, or the like. It should be noted that a single external source 125 is shown for illustrative purposes and multiple external databases may be communicated without limitation.

The operation system 130 is a component, a server, a system, or the like configured to determine and trigger the execution of a playbook for a protected entity, or entities, impacted by the cybersecurity incident. The operation system 130 receives an indication of an incident detection and retrieves input data from one or more detection tools 120. Moreover, enriched data relevant to the retrieved input data and/or the detected incident may be retrieved from the external source 125. In some embodiments, the input data and/or the enriched data associated with the detected incident may be retrieved from the database 140 that has a security data lake of the protected entity. The retrieved input data (e.g., input data, enriched data, and the like) are processed in a unified format, which may be immediately used or stored in the database 140. In an embodiment, the operation system 130 is configured to extract features (i.e., evidences or evidence inputs) from the input data according to a plurality of rules defined by, for example, but not limited to, weights, functions, scores, types, and the like, and any combination thereof. As an example, the plurality of rules may define a predefined number of features with each feature being a different type of feature. The features may be extracted from various incident related features received from one or more detection tools 120.

According to the disclosed embodiments, the operation system 130 is configured with a reasoning engine 135. The reasoning engine 135 may be an artificial intelligence (AI)-based machine learning model applied to determine a suitable protocol or playbook for resolving the incident based on conditional and causal relations between features. In an embodiment, the reasoning engine 135 is at least one machine learning model such as, but not limited to, a Bayesian belief network (BBN), a language model (LM), a large language model (LLM), or the like that is trained to represent causal relationships between various data (e.g., input data, enrichment data, system configuration data, and the like). The reasoning engine 135 has an influence diagram (ID) that expands the reasoning model to aid the determination. The causal relationship is employed to generate insights in determining the playbook. The generated insights may include, for example, but not limited to, a type of incident, at least one key feature, a root-cause, and the like, and any combination thereof that provides additional information of the detected service impact incident. The root-cause points to a reason for failing to detect or mitigate the service impact, thereby causing the impact incident to occur. It should be noted that the reasoning engine 135 described herein enables explainability in determining the suitable playbook. It should be further noted that the conditional relationships of the reasoning engine reduce the resolution time. Specifically, the disclosed embodiments reduce the time it requires to identify the root cause and to select an effective playbook for resolution of the incident.

The database 140 such as, but not limited to, data repositories or databases stores security-related data from various sources including, but not limited to, detection tools 120, operation system 130, protected entity components and/or servers, and the like. In some implementations, the database 140 may be a security data lake that consolidates data from sources such as, but not limited to, security information and event management (SIEM) systems, network logs, firewall logs, endpoints data, user activity, application logs, vulnerability management tools, threat intelligence feeds, and the like. In an embodiment, the database 140 stores incident and/or attack related data collected with respect to the protected entity.

It should be noted that operation system 130 may be deployed either in the cloud computing environment or on-premises, depending on the organization's needs, resources, and preferences. The cloud computing environment may be a public, private, or hybrid cloud. Examples of public cloud computing environments include Amazon® Web Services (AWS), Microsoft Azure, or Google® Cloud Platform (GCP), which offer shared infrastructure managed by the cloud provider, providing scalability, flexibility, and reduced infrastructure management. On-premises deployment involves operation system 130 on the organization's own servers and infrastructure, giving the organization complete control over the environment but also requiring more management and maintenance effort. This option is often chosen for systems with strict security or compliance requirements. In some configurations, the detection tool 120, the operation system 130, and/or the databases 140 may be deployed in a cloud computing platform and/or in an on-premises deployment such that they collocate together, or in a combination.

The user device 150 may be, but not limited to, a personal computer, a laptop, a tablet computer, a smartphone, a wearable computing device, or any other device capable of receiving and displaying notifications as well as receiving inputs. The notification may be presented via a graphical user interface (GPU) at the user device 150 as, for example, interactive pages, an alert, a report, and the like, and any combination thereof. The user device 150 may be accessed, for example, by a Security Operation Center (SoC) personnel, for visibility into the cybersecurity incidents, strategies, and executions of the operating system 130. In addition, the SoC personnel may provide input on such information via one or more input/output (I/O) devices. Such information associated with the operation system 130 may include, but not limited to, insights generated via the reasoning engine 135, a selected protocol, a protocol selection process including scored for each protocol, steps of the selected protocol, protocol execution progress and results, and the like, and any combination thereof.

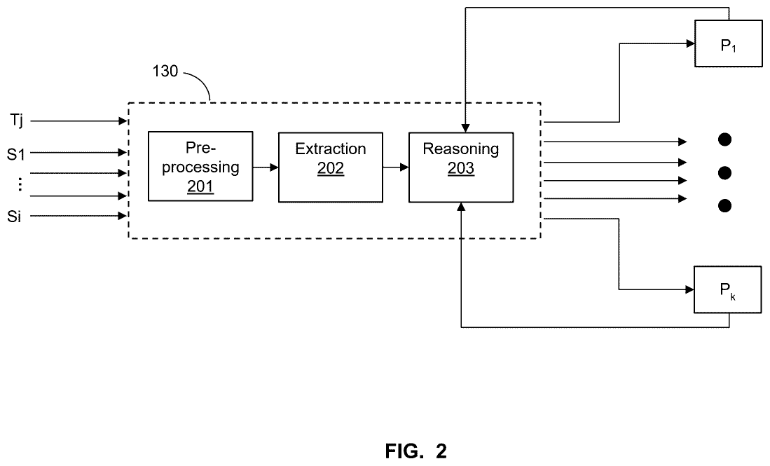

FIG. 2 is an example flow diagram 200 illustrating the AI-based operation system 130 according to an embodiment. In an embodiment, the operation system 130 may apply at least one of an unsupervised machine learning algorithm, a semi-supervised machine learning algorithm, or the like.

In the learning phase, a training dataset Tj is provided and ingested by the operation system 130 in order to train the AI-based operation system 130. A pre-processing 201 is performed to generate normalized data in the unified format and stored in a memory and/or database. The pre-processed normalized data are analyzed for extraction 202 of a predetermined number of features. In an example embodiment, the extraction 202 may be omitted and indicated as part of the training dataset Tj. The extracted features (extracted 202 or ingested as Tj) of cybersecurity incidents and related security data such as, but not limited to, traffic, log, status, and the like, are employed to train the reasoning engine 203. The training in the learning phase is performed until the reasoning engine 203 and its logical model representing causal relationships have been determined as being trained. An influence diagram may be provided or incorporated to at least one machine learning model of the reasoning engine 203 for determining resolution playbooks. In an embodiment, the influence diagram may be provided by an expert, for example, a SoC personnel. In another embodiment, the influence diagram may be automatically generated based on various security data such as, but not limited to, SoC incident brief report, and the like, that may be available via the database 140.

In the inference phase, the operation system 130 is configured to determine posterior probabilities and identify a best fit resolution playbook from the plurality of P1 through Pk as well as insights such as, but not limited to, a root-cause, a type of incident, and the like, and any combination thereof, based on received signals S1 through Si. The received signals S1 though Si are provided from at least one detection tool or plugin (e.g., security detection tool, network analytics tool, application or service health and status tool, etc.), external databases, databases, and the like, and any combination thereof. The received signals S1 through Si may be, for example, behavior data, response time of an application, network latency measure, and/or detected attack or anomaly, and the like, and any combination thereof that are relevant to a security incident within the protected organization or against the protected entity.

Once ingested by the operation system 130, the received signals S1 through Si are preprocessed 201 as the unified format, and the predetermined number of features are extracted 202. Here, the trained reasoning engine 203 is applied to identify a matching resolution playbook from a plurality of playbooks P1 through Pk. The identified matching resolution playbook is the playbook that is projected to best resolve the service impact incident with respect to, for example, but not limited to, efficacy, resolution time, completeness, and the like, and the combination thereof. In an embodiment, the received signals S1 through Si, or the extracted features of the received signals, serve as evidence sets (or evidence input) for the BBN to independently identify insights such as, but not limited to, incident type, root-cause, and the like, and any combination thereof on top of the resolution method based on the matching playbook. The root-cause indicates a reason for the failed security system (e.g., to detect, to mitigate, etc.) and may be associated with one or more playbooks that would reduce the associated root-cause. In some implementations, the reasoning engine 203 may include a language model that enables natural language communications of, for example, but not limited to, answering questions, generating suggestions, receiving and implementing feedback, providing feedback, and the like, and any combination thereof.

Moreover, feedback data may be collected with the execution of the identified playbook. Such feedback data are provided to the reasoning engine 203 to further train and optimize the reasoning model that determines the insights (e.g., root-cause, etc.) and the matching playbook. The reasoning model of the reasoning engine 203 is a classification model that is configured to generate scores in the identification of the root-cause and the matching playbook. In an embodiment, the scores are probability scores determined for nodes of various variables in the BBN and influence diagram-based reasoning model that are calculated based on the received signals S1 through Si. In an example embodiment, extracted features of the received signals S1 through Si may be utilized for determining the probability scores for the playbook nodes, evidence nodes, and the like, to identify, for example, but not limited to, the playbook, the root-cause, and more. The extracted features are added to predefined evidence nodes of the reasoning model. In some implementations, the plurality of playbooks P1 through Pk are predetermined and stored in a database (e.g., the database 140, FIG. 1). The playbook includes one or more steps that include configurations, instructions, and the like, and any combination thereof, for modifying the protected organization and/or entity, thereby mitigating a potential threat or vulnerability from the incident.

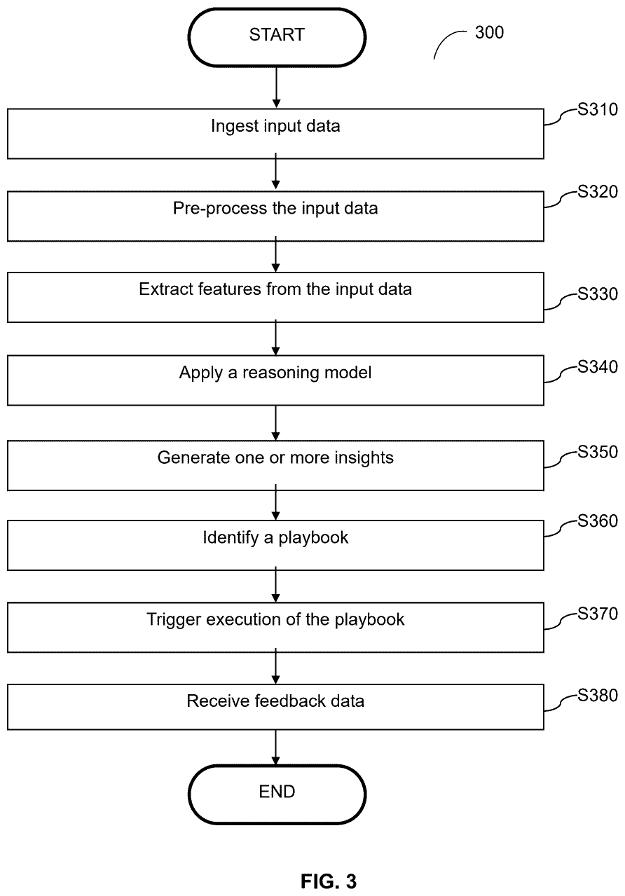

FIG. 3 is an example flowchart 300 illustrating a method for determining resolution playbook according to an embodiment. The method described herein is performed at the operation system 130, FIG. 1. The method described herein is performed at the operation system 130, FIG. 1 that has the reasoning engine 135, FIG. 1. The method is described with respect to a single incident for illustrative purposes. However, it should be noted that the process of determining a resolution playbook may be simultaneously performed for a plurality of security impact incidents detected at one or more detection systems 120. In some embodiments, a single incident is linked to multiple attack vectors and/or detection systems and associated with multiple root-causes. In such a case, multiple playbooks to be executed may be identified to resolve the single incident.

At S310, input data are ingested. The input data are behavior data associated with a service impacted by a detected cybersecurity incident at one or more detection tools (e.g., the detection tools 120, FIG. 1). In addition, the input data may be received from a personnel of the Security Operations Center (SOC) via, for example, a user device (e.g., the user device 150, FIG. 1). In an example embodiment, the input data may include enriched data from external sources (e.g., the external source 125, FIG. 1). The incident indicates a cyber security system failure to effectively mitigate a cyber-attack and may be conveyed by, for example, but not limited to, attack alerts together with high network latency, high volume of traffic that enters protected entity infrastructure, and the like, and more. The input data associated with the incident may include, for example, network configuration, traffic, logs, impact services, and the like, and any combination thereof. Metadata such as, but not limited to, an incident identifier (ID), time stamp, tool or plugin identifier (ID), and the like, and any combination thereof, may be retrieved with the respective input data. As an example, input data (e.g., logs, configurations, etc.) is retrieved from two detection tools via respective plugins.

At S320, the input data are pre-processed into a unified format. The retrieved input data are parsed and normalized into the unified format and stored in a database (e.g., the database 140, FIG. 1). In an embodiment, the input data are periodically retrieved and processed to update the unified data stored. The pre-processing for normalizing monitored data is performed in near real-time. In some embodiments, a predefined aging parameter is applied to remove stored processed input data after the predefined time period, for example, 12 hours. In an embodiment, the unified format includes multiple data fields such as, but not limited to, data type, value, various metadata (e.g., time stamp, etc.), and the like. It should be noted that input data management using the predefined aging parameters reduces the amount of input data stored at the database, thereby reducing computer memory and/or storage space. It should be further noted that the periodic updating and/or aging of input and processed data ensure most current data to be available and employed for analysis.

At S330, features, defined as evidence inputs, are extracted from the input data. A predetermined number of the features are extracted from the input data associated with the incident according to a plurality of extraction rules. The plurality of extraction rules includes weights, functions, and the like, in order to extract and generate a set of features to be input to the reasoning model and analyzed. The feature (or evidence) may be extracted by processing one or more signals. A feature is an evidence that is related to the incident and provides the probability of existence or observation of each evidence type, which may be, a hard evidence (e.g., yes or no), a soft evidence (e.g., probability of existence, etc.), or the like. An example of soft evidence (or feature) may be 30% deviation from a baseline traffic. An example of the features may include rate baseline excessive ratio indicating the relationship between network rate baselines of a first detection system to a second detection system.

The features (i.e., evidence input) are generated from the pre-processed input data that are relevant to the incident. In an embodiment, the feature extraction is initiated upon detecting an incident. In another embodiment, the feature extraction is initiated at predetermined time intervals or frequencies.

At S340, a reasoning model is applied using the extracted features. The extracted features (which servs as evidence inputs) and metadata such as, but not limited to, incident ID, of the detected incident are fed to the reasoning model to generate and output scores for a plurality of nodes of evidences and resolution playbooks. In an embodiment, the score is a probability of the node (e.g., network behavior, attack behavior, type, playbook, etc.) determined based on the fed extracted data, which are generated through inference of at least one machine learning model of the reasoning model. It should be noted that the score generated for a resolution playbook is a quantitative indicator predicting an effective resolution to the detected incident's root cause given the fed features. A resolution playbook is a multi-step instruction guiding the steps of resolving a security incident.

According to an embodiment, the reasoning model may have an AI-based classification model and an influence diagram applied to perform logical reasoning and decision-making based on the fed extracted features. In an embodiment, the reasoning model may be, for example, but not limited to, an unsupervised learning model that is constructed using expert knowledge and experiences on cybersecurity threats, vulnerabilities and the like. The reasoning model may be initially trained and further trained through realization and feedback operations. In an embodiment, the classification model is a probabilistic model such as, but not limited to, Bayesian Belief Network (BBN), and the like, which may be combined with the influence diagram to output a decision. The BBN classification model has a plurality of nodes of, for example, impact incident, type of incident, behavior or feature, and the like, that may be related to an incident and the influence diagram has a plurality of playbooks, each as individual nodes in the network of the reasoning model. In an embodiment, posterior probabilities are calculated, as scores, for the plurality of nodes in the reasoning model network based on the fed features.

In some implementations, the reasoning model may employ a generative AI model such as, but not limited to, language model (LM), large language model (LLM), and the like, and more, for example, for decision making, additional insights, feedback, and the like. In further implementations, the reasoning model may be integrated or interfaced with a natural language processing (NLP) engine that process threat intelligence information and evidence sets that are incorporated into the model for enhanced model optimization.

At S350, one or more insights for the impact incident are generated. In an embodiment, incident insights such as, but not limited to, type of service impact incident, root-cause, key feature, missing features, and the like, and any combination thereof, are determined based on the scores determined in applying the reasoning model (S330) using the extracted features. Such insights provide a logical explanation on the scores of the plurality of playbooks, selection of the resolution playbook, as well as understanding (e.g., the root-cause, key features, etc.) of the detected incident. The values for the type of incident may include, for example, but not limited to, an unnoticed false negative, a partially mitigated false negative, a non-existing false positive, an over-blocking false positive, and the like, and any combination thereof. As an example, an incident is identified as an incident type with the highest score amongst the different nodes indicating the incident types. It should be noted that some service impact incidents may not cause an actual disruption or negative impact on the related application, service, or the like.

The insights are identified based on the nodes and edges that are queried during the inference of the reasoning model network. The edges represent a relationship between two nodes and may suggest a quantified likelihood of transitioning from one node to another. In an embodiment, a root-cause analysis is performed on the inference process. In an example embodiment, the missing features may be determined upon generating scores for the playbooks that are below a predetermined threshold value. The low scores suggest that a best fitting resolution playbook is not identified and thus, the missing feature for accurate and high confidence playbook selection is determined from the nodes and/or edges. In an example embodiment, the root-cause analysis is performed by analyzing node probabilities, filtering out low probability nodes, and the like, to identify the main cause of the impact incident that occurs due to ineffective detection or mitigation by the organization's security system. One or more root-causes with high probability scores may be identified for an impact incident.

It should be noted that the generated insights provide additional relationships, particularly more impactful relationships, between the features thereby improving the accuracy and predictive capability of the reasoning model. It should be noted that such relationships and predictive capabilities allow efficient inference and identification of the resolution playbook, for reduced computing power and time. In an embodiment, the missing feature may be immediately notified, for example, via a user device that may translate to rapid input, playbook and insight identification, and resolution of the impact incident.

At S360, a matching resolution playbook is identified. The resolution playbook for the incident is selected from a plurality of resolution playbooks based on the generated scores (e.g., probabilities). As noted above, the reasoning model, having a classification model and an influence diagram, is utilized to determine scores given the input extracted features in order to select an optimal playbook for the service impact incident. In an example embodiment, the resolution playbook with a highest score is selected and identified as the matching resolution playbook. In another example embodiment, one or more resolution playbooks with scores above a predetermined threshold score may be selected as potential matching resolution playbooks. For example, an impact incident may display multiple attack vectors, multiple root-causes, or the like. In such a case, the playbook for execution may be selected from the potential matching resolution playbooks based on predefined criteria. As noted above, the playbook is a comprehensive, often multi-step, guideline for responding to security incidents. The matching resolution playbook is selected for the specific incident as a best practice for responding and/or resolving to the service impact incident and identified root cause, thereby enabling effective resolution within a shorter timeframe. The resolution playbook includes instructions for various parameters such as, but not limited to, network configuration, access control, endpoint security settings, logging and monitoring settings, data backup and recovery configurations, response tool settings, and the like, and any combination thereof and may be stored in a memory and/or a database (e.g., the database 140, FIG. 1).

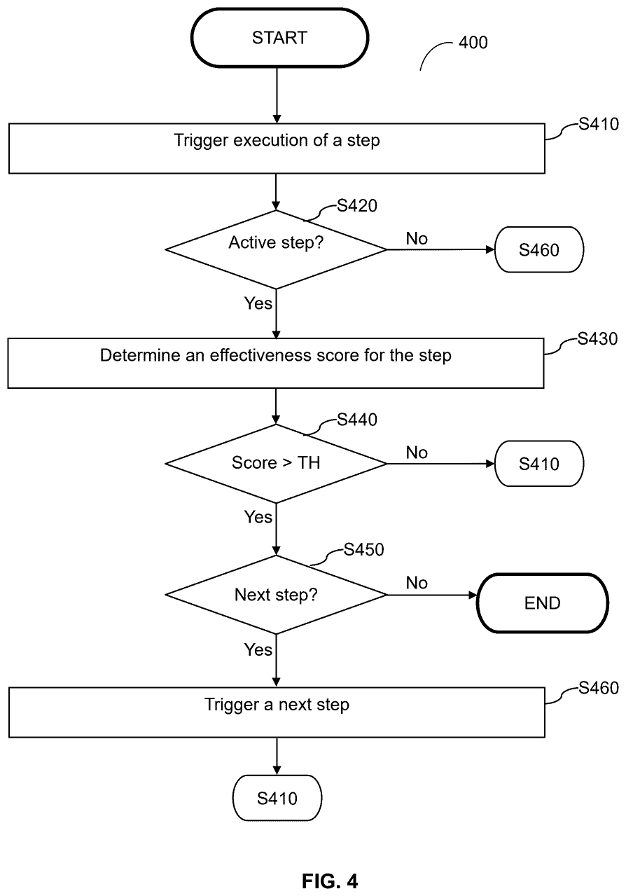

At S370, execution of the matching playbook is triggered. The matching resolution playbook identified for the detected incident is triggered to be executed. Each step of the matching playbook is executed in order to resolve and respond to the security incident. In an embodiment, the execution of the matching playbook is monitored at the operation system (e.g., the operation system 130, FIG. 1) as further described in FIG. 4 herewith. In an embodiment, the matching playbook is immediately initiated upon identification of the matching resolution. In another embodiment, the matching playbook may be triggered upon initiation by a user via a user device (e.g., the user device 150, FIG. 1).

In some embodiments, the user is provided with information on the identified matching playbook via the user device, for example, as a notification. The notification may include, for example, an incident ID, the matching playbook identifier (ID), steps of the matching playbook, the matching score, insights (e.g., type of incident, root-cause, key features, etc.), and the like, and any combination thereof. In some implementations, the user may track execution of the matching playbook through, for example, notifications, graphical user interface (GPU), and the like, and any combination thereof.

At S380, feedback is received. In an embodiment, the feedback may be received for one or more outputs of the reasoning model such as, but not limited to, selected feedback, executed feedback, generated insights, and the like, In a further embodiment, the feedback or portions thereof employed to modify the reasoning model network. As an example, the nodes, edges, probabilities, or the like, are updated based on at least a portion of the received feedback. In an embodiment, upon receiving a feedback that the executed playbook is not effective, the operation returns to S340 to apply the reasoning model on the updated input data collected with the execution of the identified playbook.

The feedback may be received via a user device (e.g., the user device 150, FIG. 1) from a personnel associated with the protected entity or organization, for example, of a Security Operation Center (SoC). In an embodiment, the user may enter the feedback as, for example, a numerical value within a predefined range, a description, and the like, and any combination thereof according to the results of executing the playbook. In another embodiment, the feedback may be received from the detection tool indicating a degree of mitigation or remediation of the detected security incident. In yet another embodiment, the feedback may be generated by the operation system (e.g., the operation system 130, FIG. 1) based on data received from the detection tools, the user device, or both. The feedback describes the mitigation status (e.g., complete mitigation, persistent mitigation, etc.) and timing (e.g., during ongoing detection, after detection ended, etc.) of the detected incident following the playbook execution.

In an embodiment, a time to recover (TTR) is measured between the initiation of the service impact incident and the termination after effective resolution using the playbook. It has been identified that the TTR may be days or even weeks depending on the incident. However, the reasoning engine described herein provides rapid and accurate determination of resolution playbooks that may be immediately executed for automatic resolution of the incident. It should be further noted that the method described herein is not limited to selecting a resolution playbook, but generated insights to support and reason the selection allowing the process to be explainable and readily scalable.

In some implementations, at least one generative AI algorithm may be applied to construct and maintain an intelligence database. Some examples of generative AI algorithm may include a language model (LM), a large language model (LLM), audio generative model, and the like, and more. The trained generative AI algorithm may be employed with the reasoning model to provide addition insights, feedback, interactions, and more.

FIG. 4 is an example flowchart 400 illustrating a method for monitoring a resolution playbook according to an embodiment. The method described herein is performed at the operation system 130 as the identified matching playbook is executed in response to the service impact incident. In an embodiment, the playbook is executed on the protected entity (not shown) communicatively connected to the operation system 130, FIG. 1. The protected entity is at least a component, a system, a server, or the like associated with the user entity of the user device 150, FIG. 1.

The method described herein is performed for each step in the playbook and repeated through completion. The playbook may include two major types of steps, for example, active steps and transition steps. The active step is carried out to apply a change or criteria to the protected system. The transition step is performed as a decision (i.e., investigate) and/or monitoring point for the execution of the next step. The transition step may be a manual transition, an automatic transition based on predetermined conditions, or both. Some examples of playbook active steps may include, for example, but not limited to, resetting baselines, updating policy parameters, modifying anomaly thresholds, modifying network traffic baselines, updating detection sensitivity parameters, adding or removing traffic filters, modifying blocking rules, and the like, and more changes in configurations. Such active steps are executed in order to influence the detected behavior and thus, evidence inputs (e.g., root-cause, etc.) towards resolution of the impact incident.

At S410, an execution of a first step in the resolution playbook is triggered. The resolution playbook includes steps to handle and/or resolve the detected security incident. In an example embodiment, the step may include one or more network configurations, which may be applied to modify the current network configuration. In an embodiment, the observations at each step of the playbook are logged. In another embodiment, the modifications in setting or configuration based on the instruction of the playbook are tracked and logged with execution. The incident information is logged and stored, for example, in a memory and/or the database (e.g., the database 140, FIG. 1).

At S420, it is checked whether the first step is an active step. If so, the operation continues with S430; otherwise, the operation continues with S450.

At S430, an effectiveness score is determined for the executed first step. The effectiveness score provides a quantitative analysis on the applied active step. In an example embodiment, the scores of the root-cause and/or service impact incident may be the used to determine the effectiveness score. Decreased scores at nodes associated with the identified root-cause, playbook, and the like, may indicate effective mitigation by the execution of the first step. Such effectiveness is provided as positive feedback and a higher effectiveness score. As an example, a positive output effective score indicates removal of the root-cause and/or the impact incident and a negative output effective score indicates otherwise. In some embodiments, the execution of the first step may raise a new root-cause to be addressed.

At S440, it is checked whether the effectiveness score is above a predetermined threshold value. If so, the operation continues to S450; otherwise, the operation continues to S410. Upon returning to S410, the execution of the first step is triggered using a different configuration, for example, modified sensitivity. Steps S410 through S430 are repeated for the first step using the different configuration (i.e., modified first step). It should be noted that an effectiveness score above the predetermined threshold value suggests successful execution and/or result of the active step.

At S450, it is checked whether a next step exists in the resolution playbook. If so, the operation continues with S460; otherwise, the operation terminates with completion of the playbook. In some embodiments, the determined effectiveness score may be utilized to determine the next step in the playbook according to at least one conditionality rule.

At S460, an execution of the next step is triggered. The next step is a subsequent step, for example a second step in the first round using the first step, in the resolution playbook that is executed and monitored. The steps of S410 through S460 are repeated in parallel to the execution of the next active step. As described above, the step of checking the effectiveness score against the threshold is also performed for the next active step in order to successfully tackle the target's service impact incident.

According to the disclosed embodiments, the execution of the playbook is monitored closely, and relevant data such as, but not limited to, configuration changes, logs, effectiveness scores, are collected and recorded. The resolution playbook may be updated during execution and/or completion of the playbook.

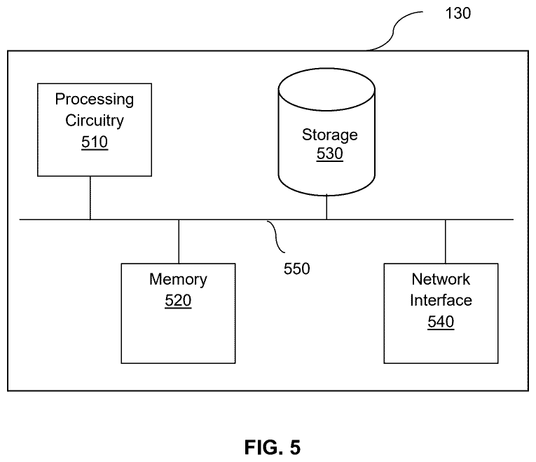

FIG. 5 is an example schematic diagram of an operation system 130 according to an embodiment. The operation system 130 includes a processing circuitry 510 coupled to a memory 520, a storage 530, and a network interface 540. In an embodiment, the components of the operation system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the operation system 130 to communicate with, for example, the detection tools 120, the external database 125, the user device 150, the databases 140, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining a resolution playbook for a cybersecurity incident, comprising:
applying a reasoning model to determine scores for a plurality of playbooks based on input data related to a root-cause of a cybersecurity incident, wherein the reasoning model includes a plurality of nodes of features and the plurality of playbooks arranged in a causal relationship;
identifying a matching playbook based on the determined scores for the plurality of playbooks; and
triggering execution of the matching playbook to resolve the cybersecurity incident.

2. The method of claim 1, further comprising:
preprocessing the input data into a unified format; and
extracting features from the input data to feed into the reasoning model, wherein the features are extracted based on a plurality of extract rules and indicate the cybersecurity incident.

3. The method of claim 1, further comprising:
determining the root-cause from the plurality of nodes of the reasoning model.

4. The method of claim 3, further comprising:
analyzing probabilities of the plurality of nodes;
filtering out low probability nodes to identify the root-cause of the cybersecurity incident that occurs due to an ineffective detection.

5. The method of claim 3, further comprising:
causing a generation of a notification describing the identified matching playbook and the determined root-cause.

6. The method of claim 1, further comprising:
generating an insight on the cybersecurity incident, wherein the generated insight is determined from the plurality of nodes.

7. The method of claim 6, wherein the insight is at least one of: a type of incident, a key feature, and a missing feature.

8. The method of claim 5, further comprising:
receiving feedback data on the notification via a user device; and
training the reasoning model based on the received feedback data.

9. The method of claim 1, further comprising:
monitoring the execution of the matching playbook until termination; and
retraining the reasoning model based on a success in resolving the cybersecurity incident.

10. The method of claim 1, wherein the reasoning model has a Bayesian belief network (BBN) and an influence diagram.

11. A non-transitory computer readable medium having stored thereon instructions for causing a processing circuitry to execute a process, the process comprising:
applying a reasoning model to determine scores for a plurality of playbooks based on input data related to a root-cause of a cybersecurity incident, wherein the reasoning model includes a plurality of nodes of features and the plurality of playbooks arranged in a causal relationship;
identifying a matching playbook based on the determined scores for the plurality of playbooks; and
triggering execution of the matching playbook to resolve the cybersecurity incident.

12. A system for determining a resolution playbook for a cybersecurity incident, comprising:
a processing circuitry; and
a memory, the memory containing instructions that, when executed by the processing circuitry, configure the system to:
apply a reasoning model to determine scores for a plurality of playbooks based on input data related to a root-cause of a cybersecurity incident, wherein the reasoning model includes a plurality of nodes of features and the plurality of playbooks arranged in a causal relationship;
identify a matching playbook based on the determined scores for the plurality of playbooks; and
trigger execution of the matching playbook to resolve the cybersecurity incident.

13. The system of claim 12, wherein the system is further configured to:
preprocess the input data into a unified format; and
extract features from the input data to feed into the reasoning model, wherein the features are extracted based on a plurality of extract rules and indicate the cybersecurity incident.

14. The system of claim 12, wherein the system is further configured to:
determine the root-cause from the plurality of nodes of the reasoning model.

15. The system of claim 14, wherein the system is further configured to:
analyze probabilities of the plurality of nodes;
filter out low probability nodes to identify the root-cause of the cybersecurity incident that occurs due to an ineffective detection.

16. The system of claim 14, wherein the system is further configured to:
cause a generation of a notification describing the identified matching playbook and the determined root-cause.

17. The system of claim 12, wherein the system is further configured to:
generate an insight on the cybersecurity incident, wherein the generated insight is determined from the plurality of nodes.

18. The system of claim 17, wherein the insight is at least one of: a type of incident, a key feature, and a missing feature.

19. The system of claim 16, wherein the system is further configured to:
receive feedback data on the notification via a user device; and
train the reasoning model based on the received feedback data.

20. The system of claim 12, wherein the system is further configured to:
monitor the execution of the matching playbook until termination; and
retrain the reasoning model based on a success in resolving the cybersecurity incident.

21. The system of claim 12, wherein the reasoning model has a Bayesian belief network (BBN) and an influence diagram.
